(19) United States
(12) Patent Application Publication
(10) Pub. No.: US 2014/0156331 A1
(43) Pub. Date: Jun. 5, 2014

(54) METHODS AND SYSTEMS FOR CONNECTING THIRD PARTY APPLICATIONS TO CROWDSOURCING COMMUNITIES

(71) Applicant: Matthew Cordasco, Corte Madera, CA (US)

(72) Inventor: Matthew Cordasco, Corte Madera, CA (US)

(21) Appl. No.: 14/097,236

(22) Filed: Dec. 4, 2013

Related U.S. Application Data
(60) Provisional application No. 61/733,508, filed on Dec. 5, 2012.

(51) Int. Cl. G06Q 10/06

(52) U.S. Cl. CPC G06Q 10/06311
USPC 705/7.15; 705/7.13

(57) ABSTRACT

Provided are computer implemented methods and systems for crowdsourcing a task. An exemplary method comprises receiving a request to source the task to a crowdsourcing community. The request is received from a crowd connector embedded in a third party application. The task is advertised to the crowdsourcing community. A contractor associated with the crowdsourcing community is selected for the task based on predetermined criteria. The selected contractor is connected to the third part application via the crowd connector. The contractor performs the task remotely.

### RELATED APPLICATIONS

This application claims the benefit of the filing date of Provisional Application No. 61/733,508 filed on Dec. 5, 2012, which is incorporated herein by reference.

### FIELD

This disclosure relates generally to data processing and, more specifically, to connecting third party applications to crowdsourcing communities.

### BACKGROUND

Crowdsourcing has been increasing in popularity and many tasks are now being outsourced using crowdsourcing approaches. Crowdsourcing typically involves distributed problem-solving and production models. In a typical crowdsourcing scenario, a crowdsourcer may broadcast a problem to a group of solvers in the form of an open call for solutions. The solvers, also referred to as the “crowd,” can submit various solutions to the problem. Contributors to the solution, in some cases, are compensated monetarily or otherwise. In some cases, the only rewards include kudos or intellectual satisfaction. Crowdsourcing may produce solutions submitted by amateurs or volunteers working in their spare time, or from experts or small businesses, which were unknown to the crowdsourcer.

Motivations of a crowdsourcer include gathering a large number of solutions or information at low cost and having a problem solved quickly. Users may be motivated to contribute by engaging in the crowdsourcing as a social activity or by financial gain. Even though crowdsourcing is in wide use, there is still a need for tools to facilitate crowdsourcing.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are computer implemented methods and systems for crowdsourcing a task. The system for crowdsourcing a task can be used to crowdsource tasks associated with third party applications or web pages. The system for crowdsourcing a task enables a crowdsourcer to submit a task associated with a third party application that can be remotely worked on by a contractor. Communications between the third party application and the system for crowdsourcing a task can be implemented by embedding a component of the system for crowdsourcing a task into the third party application. The component, which can be referred to as a crowd connector, can be embedded as an extension, add-in, plug-in, and the like. The crowd connector can insert controls in the third party application, which allow the contractor to work on the task after the task is successfully crowdsourced.

When the crowdsourcing request is received by the system for crowdsourcing a task, the system for crowdsourcing the task can advertise the task to the crowdsourcing community. The task can be advertised through a crowdsourcing application associated with the crowdsourcing community. Members of the crowdsourcing community can view the task and indicate their willingness to perform the task. A contractor can be selected from the crowdsourcing community. The selection can be based on predetermined criteria, such as experience, qualifications, ratings, and other historical data.

The contractor can be connected to the third party application via the crowd connector to allow the contractor to work on the task remotely. By using the system for crowdsourcing a task, the crowdsourcer can enjoy the benefits of employing multiple crowdsourcing platforms for various tasks such as, for example, writing, testing, or editing. Credentials for access to the crowdsourcing platforms can be stored in a database of the system for crowdsourcing a task. Data associated with the task can be stored in the database as well.

In some embodiments, the system for crowdsourcing a task can facilitate task management by monitoring submissions associated with the task and generating progress reports associated with the task.

Furthermore, the system for crowdsourcing a task can receive a confirmation of task completion from the crowdsourcer and make a payment to the contractor on behalf of the crowdsourcer.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram illustrating an example environment within which methods and systems for crowdsourcing a task can be implemented.

FIG. 2 shows a detailed block diagram of the system for crowdsourcing a task, in accordance with an example embodiment.

FIG. 3 is a flow chart illustrating a method for crowdsourcing a task, in accordance with some example embodiments.

FIG. 4 shows an example crowdsourcing workflow, in accordance with some example embodiments.

FIG. 5 shows an example crowdsourcing process, in accordance with some example embodiments.

FIG. 6 illustrates an example crowdsourcing task related to A/B testing, in accordance with some example embodiments.

FIG. 7 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail to not unnecessarily obscure the described concepts. While some concepts will be described in conjunction with the specific embodiments, it will be understood that these embodiments are not intended to be limiting.

The following detailed description refers to methods and systems for crowdsourcing a task by connecting third party applications to crowdsourcing communities.

Crowdsourcing is used to source work to a number of contractors in a form of an open call. Each of the contractors can work on a specific task within a project. The contractors are typically members of an online crowdsourcing community. The benefits of crowdsourcing include lower expenses compared to the expenses associated with hiring a professional, a large number of alternative contractors to choose from, shorter execution terms due to distribution of the tasks to a large group of people, and so forth.

However, crowdsourcing can be associated with various issues. For example, different crowdsourcing and freelancing platforms can be used for different types of tasks. For example, one platform can be used for design tasks, a different platform can be used for research, and so forth. Moreover, after a task is performed, it needs to be integrated within a project. To facilitate the crowdsourcing process, methods and systems for crowdsourcing a task are provided. To facilitate performance of the task, a crowd connector is embedded into a third party application or a web page. The crowd connector enables communication between crowdsourcing platforms and third party applications. The crowd connector can provide control elements (for example, an additional menu to allow selecting content related to the crowdsourcing task and transmitting the content to the system for crowdsourcing a task). Upon receiving the content, the system for crowdsourcing a task can advertise the crowdsourcing task associated with the content to the crowdsourcing community via crowdsourcing and freelancing platforms. Potential contractors can bid or otherwise declare their interest in the task through the crowdsourcing and freelancing platforms. Profiles of the potential contractors can be evaluated by the system for crowdsourcing a task and some of the potential contractors are selected to perform the task. Contractors submit results of their work on the task though the crowdsourcing and freelancing platforms. In some embodiments, contractors execute the task using the third party application. Connection of the contractors to the third party application is enabled through the crowd connector.

Additionally, the tasks can be worked on remotely within the environment provided by the third party application as a shared workplace for a plurality of contractors. The system for crowdsourcing a task can provide access to the third party application to the crowdsourcer and task contractors.

In some embodiments, the system for crowdsourcing a task can monitor task performance and generate reports representing the task progress. In some embodiments, the system for crowdsourcing a task can manage payment across various crowdsourcing and freelancing platforms.

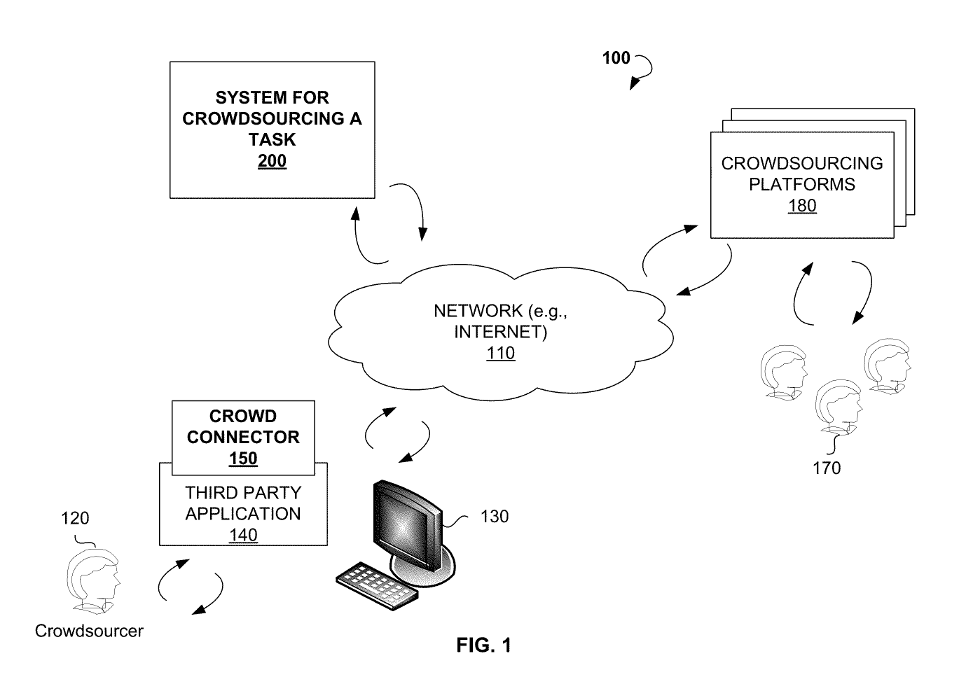

FIG. 1 is a block diagram showing an example environment 100 within which a method and system for crowdsourcing a task can be implemented. The example environment 100 may include a crowdsourcer 120 interacting with a third party application 140. The third party application 140 (also referred to as a base page) can include a web page or an editing, testing, development, or writing tool used by the crowdsourcer 120. For example, the third party application can range from a desktop application (such as Word, Excel, or PowerPoint) or Integrated Development Environment (Dreamweaver, Visual Studio, or Eclipse) to a cloud-based tool (Google doc) or web-based editing or testing tool (e.g., Squarespaces, Homestead, Optimizely, and Visual Website Optimizer).

The crowdsourcer 120 interacts with the third party application 140 via a user device 130. The user device 130 includes a mobile telephone, a computer, a laptop, a smart phone, a tablet PC, and so forth. The crowdsourcer 120, in some example embodiments, is a person interacting with the third party application 140 via the user device 130.

To facilitate crowdsourcing, a crowd connector 150 is built into the third party application 140. The crowd connector 150, in some embodiments, is a connector code (e.g., JavaScript) running on the web page or within the editing or testing tool (third party application 140). The crowd connector 150 can take a form of an extension, add-in, or plug-in (e.g., Bookmarklet) and is tightly integrated with the third party application 140.

The crowd connector 150 provides additional control elements displayed in the interface of the third-party application 140. Using the additional control elements, the crowdsourcer 120 can post crowdsourcing requests and control crowdsourcing operations. The crowd connector 150 can communicate with a system 200 for crowdsourcing a task to transmit crowdsourcing requests from the crowdsourcer 120 to a creative crowd 170 and submissions from creative crowd 170 back to the crowdsourcer 120.

The system 200 can receive a crowdsourcing request from the crowd connector 150 and post it to crowdsourcing platforms 180 to advertise to the creative crowd 170. The creative crowd 170 can include any number of independent individuals, agencies, or entities capable of receiving a request for a task, bidding on the task, and providing work products for consideration. The creative crowd 170 can perform tasks associated with the crowdsourcing request and submit the results to the crowdsourcing platforms 180 and/or to the system 200. Additionally, submissions can be transmitted to the third party application 140. Communications between the crowd connector 150, the system 200, and crowdsourcing platforms 180 can be via a network 110.

The network 110 may include the Internet or any other network capable of communicating data between devices. Suitable networks can include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may be a network of data processing nodes that are interconnected for the purpose of data communication.

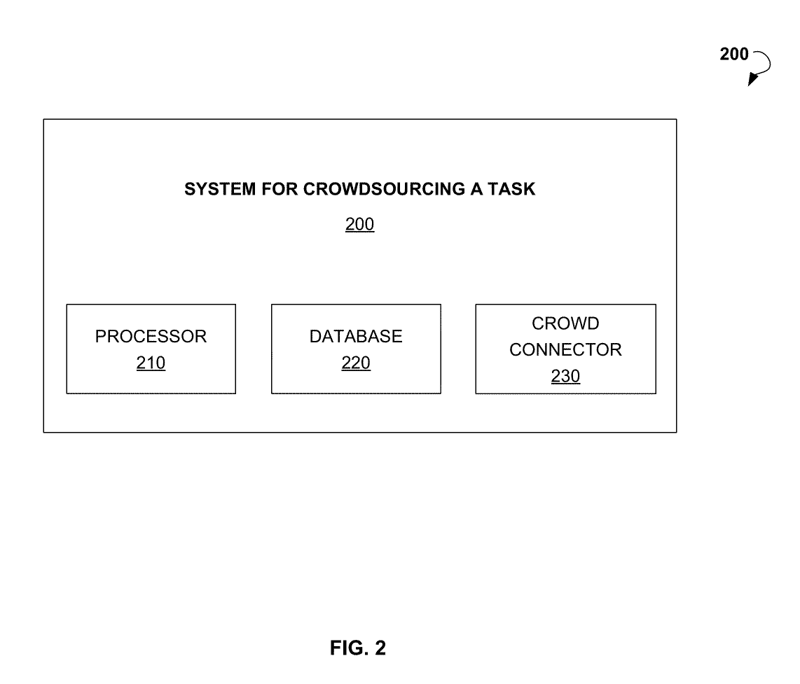

FIG. 2 shows a detailed block diagram of the system 200 for crowdsourcing a task, in accordance with an example embodiment. The system 200 may include a processor 210, a database 220, and a crowd connector 230. The processor 210 can include a programmable processor, such as a microcontroller, central processing unit (CPU), and so forth. In other embodiments, the processor 210 can include an application-specific integrated circuit (ASIC) or programmable logic array (PLA), such as a field programmable gate array (FPGA), designed to implement the functions performed by the system 200. Thus, the processor 210 can receive a request to source a task to a crowdsourcing community. The request can be transmitted by the crowd connector 230 embedded in a third party application associated with a crowdsourcer. The processor 210 can advertise the task to a crowdsourcing community and select a contractor for the task based on predefined criteria. The criteria can be specified by the crowdsourcer and can include a desired experience level, acceptable payment options, a contractor rating, and so forth. The crowd connector 230 can connect the selected contractor to the third party application to enable the contractor to perform the task remotely.

The database 220 can store the request for crowdsourcing the task as well as accounts associated with the crowdsourcer and crowdsourcing platforms, crowdsourcer preferences and predefined criteria, selected contractors and submitted results of their work, and other data.

The crowd connector 230 is a module enabling connection of the system 200 and a third party application used by a crowdsourcer. The module is integrated into the third party application with or without consent of the crowdsourcer. Integration can be implemented by various methods. For example, the crowd connector 230 can be built into the third party application as an application add-in, a browser plug-in (e.g., a Bookmarklet instantiated JavaScript code), a tag management system, embedded referential links to the system 200, dynamic loading of a library associated with the system 200, and so forth.

In some embodiments, the system 200 stores data associated with membership of crowdsourcers, A/B testing vendors, operators, and creative crowds. Additionally, the system 200 can store data associated with terms, finances, fulfillment, and assets related to various transactions. Moreover, the system 200 can keep track of hours, billing, commissions, and royalties.

The system 200 can be configured to keep track of various resources associated with project requests, proposed work, and final work products. Thus, for example, the system 200 can host documents, spreadsheets, presentations, HTML files, CSS files, JavaScript code, images, or other resources needed to render a page. In certain embodiments, the technology may be implemented with core servers or via a global Content Delivery Network (such as Akamai or CloudFront).

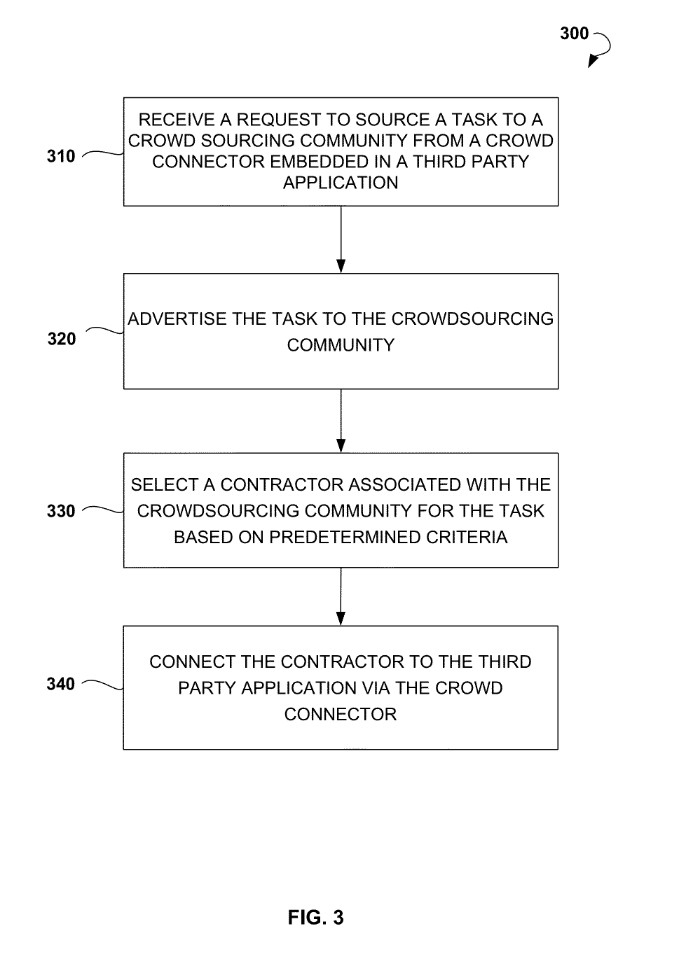

FIG. 3 is a flow chart illustrating a method 300 for crowdsourcing a task, in accordance with some example embodiments. The method 300 may be performed by logic that may comprise hardware (e.g., dedicated logic, programmable logic, and microcode), software (such as software run on a general-purpose computer system or a dedicated machine), or a combination of both. In one example embodiment, the processing logic resides at the system 200 for crowdsourcing a task, and the various elements of the system 200 can perform the method 300. It will be appreciated by one of ordinary skill that examples of the foregoing modules may be virtual, and instructions said to be executed by a module may, in fact, be retrieved and executed by software. Although various elements may be configured to perform some or all of the various operations described herein, fewer or more elements may be provided and still fall within the scope of various embodiments.

As shown in FIG. 3, the method 300 may commence at operation 310 with receiving a request to source a task to a crowdsourcing community. The request is received from a crowd connector, which connects web pages or HTML-based applications to a creative crowd. The purpose of the request can be creating alternate designs, layouts, content, text, code, HTML, CSS or images to develop new products or replace some or all elements of an existing product or web page. The request can be associated with mobile, tablet, or desktop environments. Additionally, the request can be associated with operating systems that utilize HTML for their applications or operating system.

The request can include a task description, data on timing, payments, and so forth. In some embodiments, the crowdsourcer can modify or provide additional information related to the request (e.g., description of the task, timing data, and payment data).

To facilitate request sending, the crowd connector provides control elements in the third party application accommodating the crowd connector. Thus, the crowd connector can insert menus or buttons, or produce an overlay or insert menus on top of the third party application. In some embodiments, the control elements can include the following: request a new design, review completed designs, load previously completed HTML, images, designs, or content, and so forth.

On receiving the request for task crowdsourcing, the system 200 advertises the task to the crowdsourcing community at operation 320. For this purpose, the system 200 submits the task to multiple crowdsourcing and freelancing platforms. The system 200 stores user accounts to access the crowdsourcing and freelancing platforms, so crowdsourcer workload is significantly eased. The crowdsourcer selects data related to the task and gives a command to source the task immediately from the writing or editing tool he uses.

In some embodiments, the system 200 processes the request to classify the associated task. For example, the system 200 can classify the task as a development task, a design task, an A/B testing task, a research task, a copyright task, and so forth. Based on the classification, the system 200 identifies crowdsourcing and freelancing platforms matching the task. Thus, for a research task, the system 200 will identify the crowdsourcing and freelancing platforms intended for research. The system 200 will advertise the classified task in the crowdsourcing and freelancing platforms identified as matching the task class.

Regardless of the differences in the workflows and requirements across different crowdsourcing platforms, the system 200 provides a standardized environment for requests, submissions, and billing to the crowdsourcer. For example, some crowdsourcing platforms require advance payment and others bill the crowdsourcer upon delivery of the completed task. Some crowdsourcing platforms allow running a contest, while others provide only a flat fee option. The system 200 allows the crowdsourcer to define his preferences with respect to billing, payments, terms, qualifications of task contractors, and so forth. The system selects crowdsourcing platforms and/or options according to the preferences across multiple platforms.

The system 200 enables any professional and billing relationships, including but not limited to the following: free, volunteer, work for hire, work for trade, direct hiring, fixed bid contract, hourly pricing, page view pricing, results-based pricing, performance based pricing, auctions, or contest-based pricing.

The creative crowd may review the task via the crowdsourcing platforms. Potential contractors who desire to perform the task can submit their bids or proposals. In some embodiments, the system 200 selects one or more of the potential contractors to perform the task based on predetermined criteria at operation 330. The criteria can include a minimum experience of a contractor, a minimum number of successfully performed tasks, a rating of the contractor, and the like. Furthermore, data on the one or more contractors selected by the system 200 can be provided to the crowdsourcer. The crowdsourcer can make a final choice, reject certain contractors, provide a command to repeat the selection process, modify selection criteria, and so forth.

At operation 340, the contractor is connected to the third party application via the crowd connector. The contractor can submit the results of his work on the task, review submissions of other contractors, and so forth.

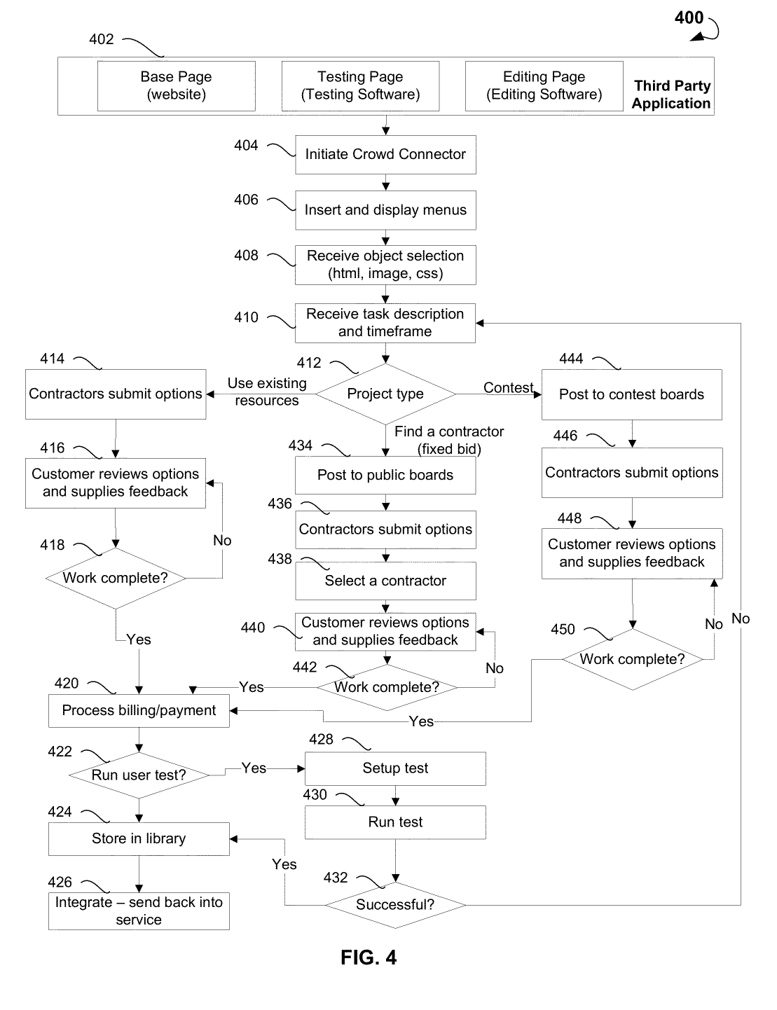

FIG. 4 shows an example crowdsourcing workflow 400, in accordance with some embodiments. The starting point of the workflow 400 is a third party application 402 associated with a crowdsourcer or a task to be crowdsourced. The third party application 402 may include a base page (web site), a testing page, or editing page managed by the third party application 402.

The crowdsourcer initiates the crowd connector 404 in the third party application 402 to facilitate crowdsourcing a task. The crowd connector inserts and displays menus 406 in the third party application 402, for example, as an overlay over the content in the third party application 402. Using the menus, the crowdsourcer selects an object associated with the task 408. The object can be a fragment of HTML or CSS code, an image, a text, and so forth. Additionally, the crowdsourcer can provide a task description and timeframe 410. The crowd connector transmits the object selection and/or additional information, such as task description and timeframe, to the system 200.

The system 200 processes the received data to determine a project type associated with the task 412. For example, the project type can be a contest, a project requiring existing resources, or a task to be performed with a fixed bid. Workflows can be different for different project types.

The project requiring existing resources can request a creative crowd to provide some resources they possess (for example, photography, design work, and so forth). Contractors submit options 414 according to the task description. A customer (or crowdsourcer) reviews provided options and supplies feedback 416. Thus, the customer can accept one or more of the submitted options and the work can be considered complete 418. If the customer has rejected the submitted options or accepted the options to partially cover the project needs, the work can be considered incomplete. In this case, the customer continues reviewing options.

As to a contest project, the workflow for this project type includes posting the task to contest boards 444. An example task for this project type can be creating a logotype for a startup. Contractors perform the task and submit options 446. The customer reviews the options and supplies feedback 448. The feedback includes selection of one of the options as a contest winner. When an option is selected, the work is considered completed 450. The contactor whose work is selected by the customer is considered the contractor of the task and receives the payment.

When the project is associated with a contractor finding, a task request is posted to public boards 434. Contractors submit options 436 of their proposals for the task. The system 200 selects a contractor 438 based on predefined criteria. The customer reviews the selected contractor or contractors and supplies feedback 440. That is, the customer approves one of the contractors to perform the task or rejects the selected contractor and continues reviewing options provided by the system 200. The selected contractor submits work results for customer review.

When the work is complete 418, 422, 450, the system 200 processes billing/payment 420 and provides an option of running a user test 422. The system 200 sets up 428 and runs 430 the test. If the test is successful 432, the work results are stored in a library 424 associated with the task and integrated 426 in the base page or testing/editing page. If the test is unsuccessful, the workflow repeats from the operation 410.

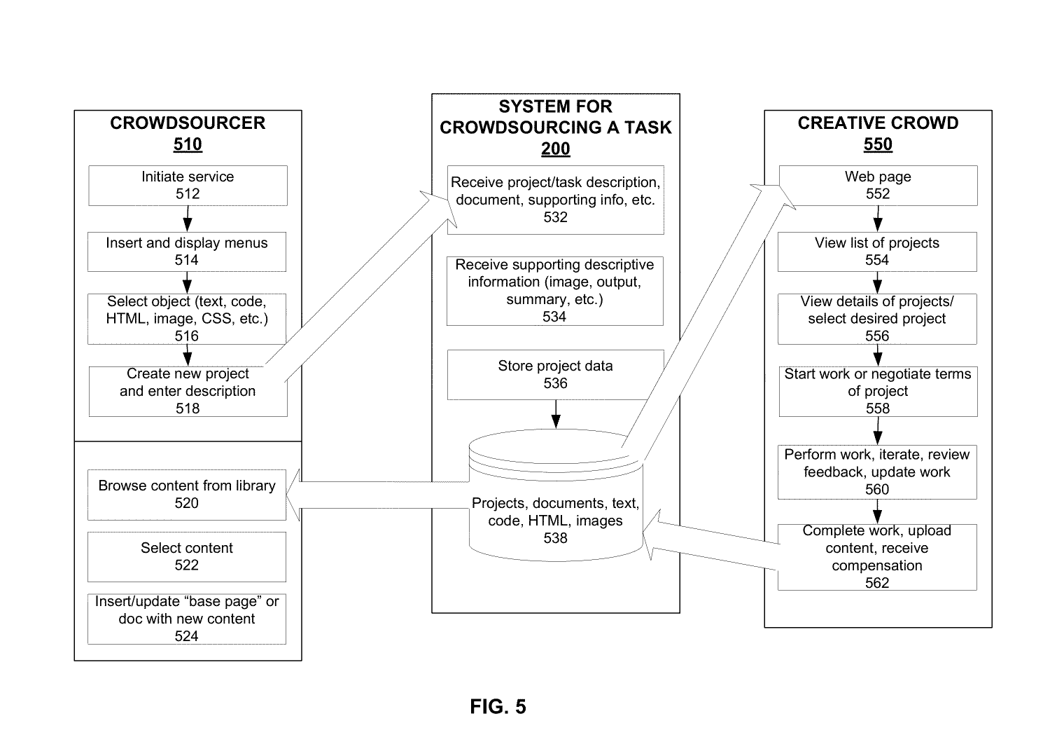

FIG. 5 shows an example crowdsourcing process, in accordance with some example embodiments. The crowdsourcing process includes at least a crowdsourcer 510, a system 200 for crowdsourcing a task, and a creative crowd 550. On a crowdsourcer side, a crowd connector is activated 512 to connect workflows from a base page or the editing or testing tool, through the system 200 and to the creative crowd 550. This may be a two-way connection: sending content out to request services or loading content/images back into the editing or testing tool or base page.

When running within the editing or testing tool or an application, the technology may act like an application within an application, offering the crowdsourcer 510 additional options related to crowdsourcing by inserting and displaying menus 514. When creating, editing, testing, or improving the base page or another product, several tasks may be executed. These tasks can be common and require an expertise of a creative individual. To request execution of the tasks by the creative crowd 550, the crowdsourcer 510 selects an object 516 associated with the task and creates a new project and provides the description 518 of the task. The task request, including a task description, documents, supporting information, and so forth, is received by the system 200. Additionally, the system 200 can receive additional information related to the task, such as supportive descriptive information, timing and payment data, and so forth.

The system 200 stores the project data 536 in a database 538. The project data is provided to the creative crowd 550 via a web page 552. The web page 552 can include a third party crowdsourcing platform or can be a part of the system 200.

Potential contractors from the creative crowd 550 view the list of projects 554 provided in the web page 552, view project details, and select a desired project 556. The system 200 and/or the crowdsourcer 510 selects potential contractors and approves one or more contractors to execute the task. The contractor starts work or negotiates project terms 558. The contractor performs the work, iterates, reviews crowdsourcer feedback, and updates the work 560. When the work is complete, the contractor uploads work results to the database 538 and receives the compensation from the crowdsourcer.

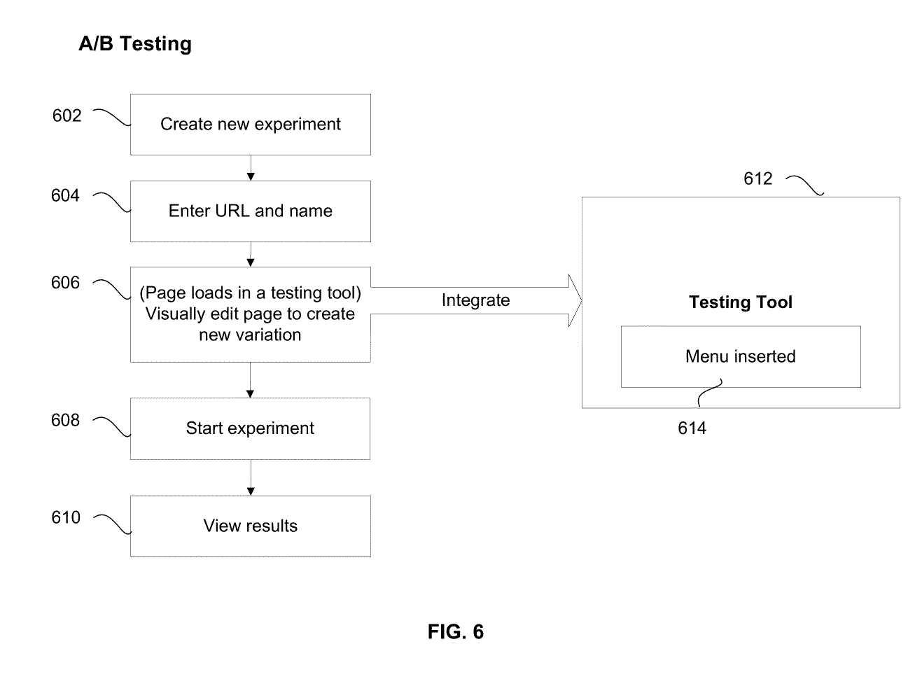

FIG. 6 illustrates an example crowdsourcing task related to AB testing, in accordance with some example embodiments. A/B tests are used to improve existing content or starting from scratch. Two variants, A and B, are tested in randomized experiments, and parameters (e.g., click-through rate) are monitored to each of the variants to determine which variant may impact user behavior. For A/B tests, a special testing tool is typically used (e.g., Optimizely, Visual Website Optimizer). Via the testing tool, alternative designs for a web page are created and tests are run to evaluate the variations. Thus, an example A/B testing process includes creating a new experiment 602 for A/B testing. A URL of the web page to be tested and a name for the experiment are entered 604. The web page loads in the testing tool. The page needs to be visually edited 606 to create variations. These variations will be tested via A/B tests. Visually editing the web page can take some time and require expertise, so this task can be crowdsourced. With the system 200, the task can be crowdsourced immediately from the testing tool 612. A menu 614 associated with the system 200 is inserted in the testing tool 612. Using the menu 614, the crowdsourcer posts a request for crowdsourcing the task. For example, the crowdsourcer can select an object that needs visual editing. The object can be a button, a menu, an image, a text, and so forth. Additionally, the crowdsourcer can provide a description, timing and payment data, supportive images, and other data.

The system 200 posts the task request to crowdsourcing platforms. The system 200 selects a contractor for the task and connects the contractor to the testing tool 612 via the system 200. The contractor uses the testing tool 612 to create variations, and the crowdsourcer approves the task completion. The created variations are integrated to the web page and the experiment is started 608. The results are provided to the crowdsourcer 610.

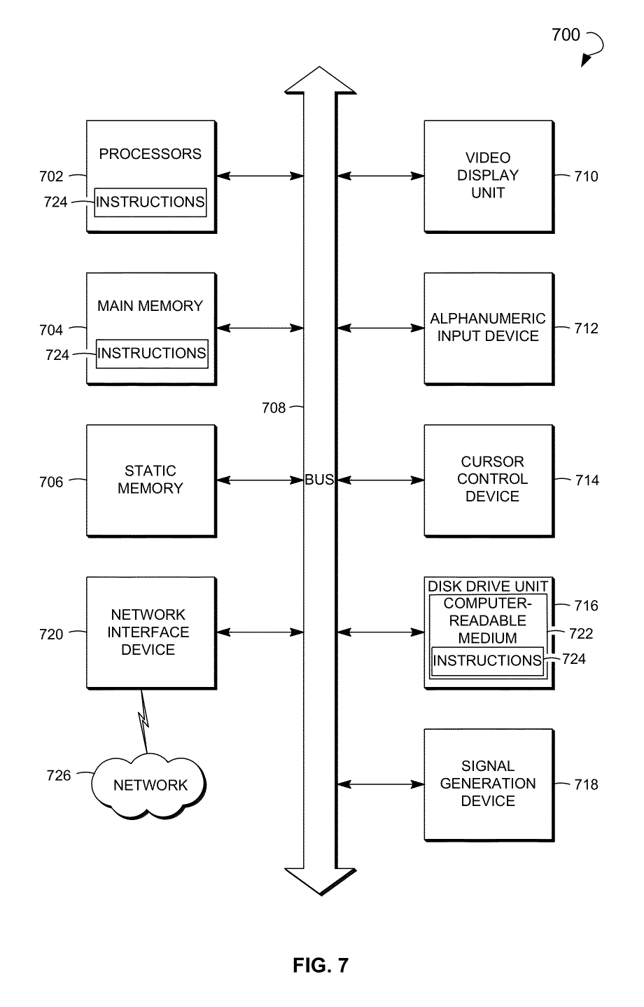

FIG. 7 shows a diagrammatic representation of a computing device for a machine in the exemplary electronic form of a computer system 700, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box (STB), a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702, a hard disk drive 704, a main memory 706, and a static memory 708, which communicate with each other via a bus 710. The computer system 700 may also include a network interface device 712. The hard disk drive 704 may include a computer-readable medium 720, which stores one or more sets of instructions 722 embodying or utilized by any one or more of the methodologies or functions described herein. The instructions 722 can also reside, completely or at least partially, within the main memory 706 and/or within the processors 702 during execution thereof by the computer system 700. The main memory 706 and the processors 702 also constitute machine-readable media.

While the computer-readable medium 720 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, RAM, ROM, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, C++, C# or other compilers, assemblers, interpreters or other computer languages or platforms.

Thus, various systems and methods for crowdsourcing a task have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A computer-implemented method for crowdsourcing a task, the method comprising:
receiving, by a processor, from a crowd connector embedded in a third party application, a request to source the task to a crowdsourcing community;
advertising, by the processor, the task to the crowdsourcing community;
selecting a contractor associated with the crowdsourcing community for the task based on predetermined criteria; and
connecting the contractor to the third party application via the crowd connector, wherein the task is performed by the contractor remotely.

2. The method of claim 1, wherein the task includes one or more of a software development task, a testing task, a copywriting task, a research task, and a design task.

3. The method of claim 1, wherein the third party application includes a browser, a web page, an editing tool, a development tool, a testing tool, and a web document.

4. The method of claim 1, wherein the contractor submits results of performing the task.

5. The method of claim 4, further comprising monitoring the submissions associated with the task.

6. The method of claim 5, further comprising generating a progress report associated with the task.

7. The method of claim 1, further comprising receiving additional information associated with the task.

8. The method of claim 7, wherein the additional information includes a description of the task, timing data, and payment data.

9. The method of claim 1, wherein the crowd connector is embedded in the third party application as one or more of an application plug-in, an application add-in, through a tag management system, and by embedding referential links.

10. The method of claim 1, further comprising:
providing, to a crowdsourcer associated with the task, data related to one or more potential contractors, the one or more potential contractors being preselected, based on the predefined criteria, by the processor from a plurality of potential contractors who expressed willingness to perform the task;
receiving, from the crowdsourcer, a selection of the contractor.

11. A system for crowdsourcing a task, the system comprising:
a processor configured to:
receive from a crowd connector embedded in a third party application, a request to source the task to a crowdsourcing community,
advertise the task to the crowdsourcing community;
select a contractor associated with the crowdsourcing community for the task based on predetermined criteria; and
connect the contractor to the third party application via the crowd connector, wherein the task is performed by the contractor remotely; and
a database communicatively coupled to the processor and configured to store at least the request, the task, and credentials associated with the crowdsourcing community.

12. The system of claim 11, wherein the task includes one or more of a development task, a testing task, a copywriting task, a research task, and a design task.

13. The system of claim 11, wherein the third party application includes a browser, a web page, an editing tool, a development tool, a testing tool, and a web document.

14. The system of claim 11, wherein the crowd connector is embedded in the third party application as an application plug-in, an application add-in, through a tag management system, and by embedding referential links.

15. The system of claim 11, wherein the processor is further configured to:
process the request to classify the task associated with the request; and
determine one or more crowdsourcing platforms in the plurality of crowdsourcing platforms matching the task, wherein the task is advertised via the one or more crowdsourcing platforms.

16. The system of claim 11, wherein the processor is further configured to:
monitor submissions associated with the task; and
generate one or more progress reports representing completion status of the task.

17. The system of claim 11, wherein the processor is further configured to receive additional information associated with the task, the additional information including a description of the task, timing data, and payment data.

18. The system of claim 11, wherein the processor is further configured to:
receive, from a crowdsourcer associated with the task, a confirmation of completion of the task by the contractor; and
based on the confirmation, manage payments associated with the task.

19. A non-transitory computer-readable medium comprising instructions, which when executed by one or more processors, perform the following operations:
receive, from a crowd connector embedded in a third party application, a request to source a task to a crowdsourcing community;
advertise the task to the crowdsourcing community;
select a contractor associated with the crowdsourcing community for the task based on predetermined criteria; and
connect the contractor to the third part application via the crowd connector, wherein the task is performed by the contractor remotely.

20. The non-transitory computer-readable medium of claim 19, wherein the task includes a development task, a testing task, a copywriting task, a research task, and a design task.
